(19) United States
(12) Patent Application Publication
(10) Pub. No.: US 2025/0358315 A1
(43) Pub. Date: Nov. 20, 2025

(54) LOCAL DETECTION OF FRAUDULENT WEBSITES USING LIGHTWEIGHT MACHINE LEARNING MODELS

(71) Applicant: Microsoft Technology Licensing, LLC, Redmond, WA (US)

(72) Inventors: Andrew James RITZ, Sammamish, WA (US); Bharat KUMAR, Kirkland, WA (US); Michael Joseph ENS, Redmond, WA (US); Amritam SARCAR, Sammamish, WA (US); Roberto Anthony FRANCO, Seattle, WA (US); Jeffrey Richard GOUR, Seattle, WA (US); Benjamin Jon BAMESBERGER, Bellevue, WA (US)

(73) Assignee: Microsoft Technology Licensing, LLC, Redmond, WA (US)

(21) Appl. No.: 18/669,212

(22) Filed: May 20, 2024

(51) Int. Cl. H04L 9/40; G06V 30/19

(52) U.S. Cl. CPC H04L 63/1483; G06V 30/19173

(57) ABSTRACT

This disclosure describes a fraudulent website detection system that provides a framework for locally detecting fraudulent websites on a client device. For example, using a local lightweight machine learning model, the fraudulent website detection system can detect and respond to fraudulent websites in real time. In some examples, the fraudulent website detection system is integrated into a web browser to promptly identify fraudulent websites. Moreover, the fraudulent website detection system, operating on multiple client devices, can collaborate with an online threat detection system to quickly notify other client devices about fraudulent websites and to utilize aggregated reports to improve the lightweight machine learning model.

### BACKGROUND

The progress in technology and computer systems has brought several benefits and advantages. Unfortunately, these advancements have also led to increased opportunities for malicious behaviors and deception. For example, malicious websites pretend to be legitimate to trick users into revealing personal or financial information. These types of scams are technologically sophisticated, which makes them challenging to detect. In particular, many are deployed on cloud infrastructure, allowing them to launch an attacking website, quickly attack users, and have it vanish within a few hours before existing systems can detect it. For example, last year, a single scam website was able to attack 30,000 users in its first hour and vanished after three hours, many hours before it was detected by threat detection services. Therefore, despite technological advancements, current systems are still not adequately equipped to detect and prevent such scams.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of a fraudulent website detection system configured to detect fraudulent websites in real time using a lightweight machine learning model located on a client device.

FIG. 2 illustrates an example computing environment in which the fraudulent website detection system is implemented.

FIG. 3 illustrates a graphical user interface of a fraudulent website that initially appears as a legitimate website.

FIG. 4 illustrates an example state diagram of the process of locally detecting fraudulent websites on a client device.

FIG. 5 illustrates an example flow diagram of training a lightweight machine learning model that executes on a client device.

FIG. 6 illustrates an example flow diagram of implementing the lightweight machine learning model on a client device to detect fraudulent websites.

FIG. 7 illustrates an example flow diagram of performing one or more reporting actions when a fraudulent website is locally detected.

FIG. 8 illustrates an example series of acts in a computer-implemented method for determining one or more fraudulent websites locally on a computing device.

FIG. 9 illustrates example components included within a computer system used to implement the fraudulent website detection system.

### DETAILED DESCRIPTION

This disclosure describes a fraudulent website detection system that provides a framework for locally detecting fraudulent websites on a client device. For example, using a local lightweight machine learning model, the fraudulent website detection system can detect and respond to fraudulent websites in real time. In some examples, the fraudulent website detection system is integrated into a web browser to promptly identify fraudulent websites. Moreover, the fraudulent website detection system, operating on multiple client devices, can collaborate with an online threat detection system to quickly notify other client devices about fraudulent websites and utilize aggregated reports to improve the lightweight machine learning model.

Implementations of the present disclosure provide benefits and solve problems in the art with systems, computer-readable media, and computer-implemented methods by using a fraudulent website detection system to detect fraudulent websites in real time on local client devices. As described below, in various implementations, the fraudulent website detection system utilizes a small, lightweight machine learning model, such as a classifier model, to determine and block fraudulent websites. In particular, the fraudulent website detection system improves efficiency, accuracy, and flexibility by enabling local detection of fraudulent websites in real time instead of relying on slower remote detection systems.

To elaborate, in various implementations, the fraudulent website detection system determines fraudulent websites locally on a client device. For example, when a website is loaded, the fraudulent website detection system captures an image of the website. Additionally, the fraudulent website detection system generates classification scores for the website using a threat assessment machine learning model based on the image or snapshot of the webpage and website request information, where the model is executed locally on the client device. The fraudulent website detection system also determines a threat potential score for the website by aggregating a subset of the classification scores. Based on the threat potential score for the website satisfying one or more threat thresholds, the fraudulent website detection system performs actions to report the website as fraudulent to prevent further fraudulent activity.

As described in this disclosure, the fraudulent website detection system delivers several significant technical benefits in terms of improved efficiency, accuracy, and flexibility compared to existing systems. Moreover, the fraudulent website detection system provides several practical applications that address problems related to quickly detecting and preventing fraudulent websites from attacking users on client devices.

To illustrate, the fraudulent website detection system improves efficiency by executing a machine learning model on a client device to detect fraudulent websites. Unlike conventional systems that rely on remote systems with large, computationally expensive models, the fraudulent website detection system uses a small, computationally lightweight machine learning model to determine a threat potential score for the website.

Moreover, in many implementations, the fraudulent website detection system uses a set of filters on the client device to determine whether to execute the threat assessment machine learning model. In particular, in these implementations, the fraudulent website detection system performs a set of low-computational verifications to determine if the threat assessment machine learning model should be run on the website. In some implementations, the fraudulent website detection system runs one or more mid-level computational verifications to further determine if the website is a candidate fraudulent website. In these implementations, only after performing one or more lower-cost computational verifications does the fraudulent website detection system implement the threat assessment machine learning model.

As another example, in some implementations, the fraudulent website detection system reports verdicts of fraudulent websites to an online threat detection system. When several client devices report the same fraudulent website, the online threat detection system can update a block list and send it out to other client devices configured with instances of the fraudulent website detection system. In these instances, these other client devices can block the fraudulent website without needing to run the threat assessment machine learning model, which also saves on computing costs (e.g., the fraudulent website is caught when running one of the low-computational verification filters).

Additionally, the fraudulent website detection system improves the accuracy of computing devices. For context, many fraudulent websites use cleverly disguised tactics to hide their intent within the document object manager (DOM) of a website. For example, rather than including a 10-digit phone number in the DOM that a threat detection system can parse, process, and recognize, the fraudulent websites strategically place the digits in different locations in the DOM so they skip detection. Then, at rendering, the 10-digit phone number is displayed together. In contrast, by capturing an image or screenshot of a website, the fraudulent website detection system can analyze it as seen by the user. In the above example, the screenshot shows the 10-digit phone number displayed together even if it is hidden throughout the backend. By using the screenshots, the fraudulent website detection system allows computing devices to more accurately process data as it is presented to users.

Moreover, the fraudulent website detection system improves computing flexibility. Existing systems include remote systems and large models that are slow to detect and react. The fraudulent website detection system uses lightweight machine learning models locally executed on client devices. Additionally, the fraudulent website detection system can detect a fraudulent website in real time as it is being loaded and displayed to a user rather than hours after the user is attacked. Thus, unlike existing systems, the fraudulent website detection system can prevent attacks before fraudulent behavior from fraudulent websites fully occurs.

Overall, the fraudulent website detection system solves the “Patient 0” problem that existing systems fail to address. That is, with existing systems, multiple users fall victim to a scam website before the website is discovered, which is often too late. Rather, the fraudulent website detection system works in real time to catch scam websites and prevent fraudulent actions. Additionally, the fraudulent website detection system can also quickly identify fraudulent websites to other client devices (e.g., via a remote listening service) before other client devices visit the scam website.

As illustrated in the above discussion, this disclosure utilizes a variety of terms to describe the features and advantages of one or more described implementations. To illustrate, this disclosure describes the fraudulent website detection system in the context of a client device.

For example, the term “fraudulent website” refers to an illegitimate internet site designed with the intent to deceive users into engaging in fraudulent or malicious activities. A fraudulent website enables scammers (e.g., bad actors) to create deceptive websites that employ false security alerts, fake giveaways, and other formats to create an illusion of legitimacy. Fraudulent websites are designed to trick users into revealing personal or financial information, perpetrating identity theft, or engaging in credit card fraud. These sites can appear through various communication channels, such as social media, email, or text messages, and may even manipulate search results to lead unsuspecting users into their traps.

As another example, the term “digital image” (or simply “image”) refers to a digital graphics file that, when rendered, displays one or more objects. Specifically, an image can include a screenshot, screen capture, screen grab, or screen recording of a browser window that captures a webpage as it appears to a user.

Additionally, as an example, the terms “executed locally,” “local processing,” or “local” refer to operations that occur on one or more processors of a client device associated with a user. In particular, local execution of a machine learning model, such as a threat assessment machine learning model, includes running the machine learning model on a client device and foregoing running or executing the machine learning model on a remote device, either in whole or in part.

For example, the term “machine-learning model” refers to a computer model or computer representation that can be trained (e.g., optimized) based on inputs to approximate unknown functions. For instance, a machine-learning model can include (but is not limited to) an autoencoder model, a classification model, a neural network (e.g., a convolutional neural network or deep learning model), a decision tree (e.g., a gradient-boosted decision tree), a linear regression model, a logistic regression model, or a combination of these models.

Additionally, as an example, the terms “small machine learning model” or “lightweight machine learning model” refer to computationally efficient models designed to achieve satisfactory performance while minimizing resource consumption. Lightweight machine learning models are specifically tailored for scenarios with limited computational resources and/or where efficiency and speed are significant, such as client devices (including laptops and mobile devices), edge computing, and battery-operated systems. Unlike their resource-intensive counterparts, lightweight models prioritize simplicity, compactness, and speed, making them well-suited for real-world efficiency-based applications. An example of a lightweight machine learning model is the threat assessment machine learning model described in this document, which may be a SoftMax classifier machine learning model that generates classification scores for different classifications or classification types.

As an example, a “large generative model” (LGM) is a large artificial intelligence system that uses deep learning and a large number of parameters (e.g., in the billions or trillions), trained on one or more vast datasets to produce fluent, coherent, and topic-specific outputs (e.g., text and/or images). In many instances, a generative model refers to an advanced computational system that uses natural language processing, machine learning, and/or image processing to generate coherent and contextually relevant human-like responses.

Similarly, a “small generative model” (SGM) is a lightweight, smaller generative model with fewer parameters. Unlike their larger counterparts, SGMs operate efficiently within resource constraints and are designed for scenarios where computational resources, memory, or model size are limited. Despite their reduced complexity, SGMs still exhibit the ability to generate coherent and contextually relevant outputs, albeit on a smaller scale. In some instances, the fraudulent website detection system utilizes an SGM to locally detect fraudulent websites on a client device.

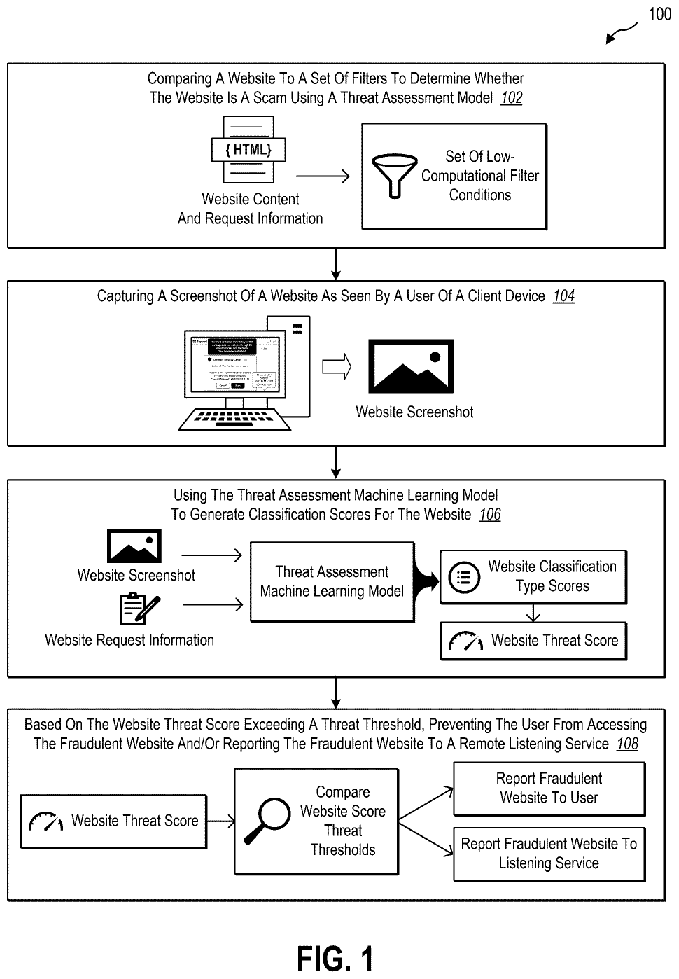

Implementation examples and details of the fraudulent website detection system are discussed in connection with the accompanying figures, which are described next. For example, FIG. 1 illustrates an overview example of the fraudulent website detection system configured to detect fraudulent websites in real time using a lightweight machine learning model located on a client device according to some implementations. As shown, FIG. 1 includes a series of acts 100 performed by or with the fraudulent website detection system.

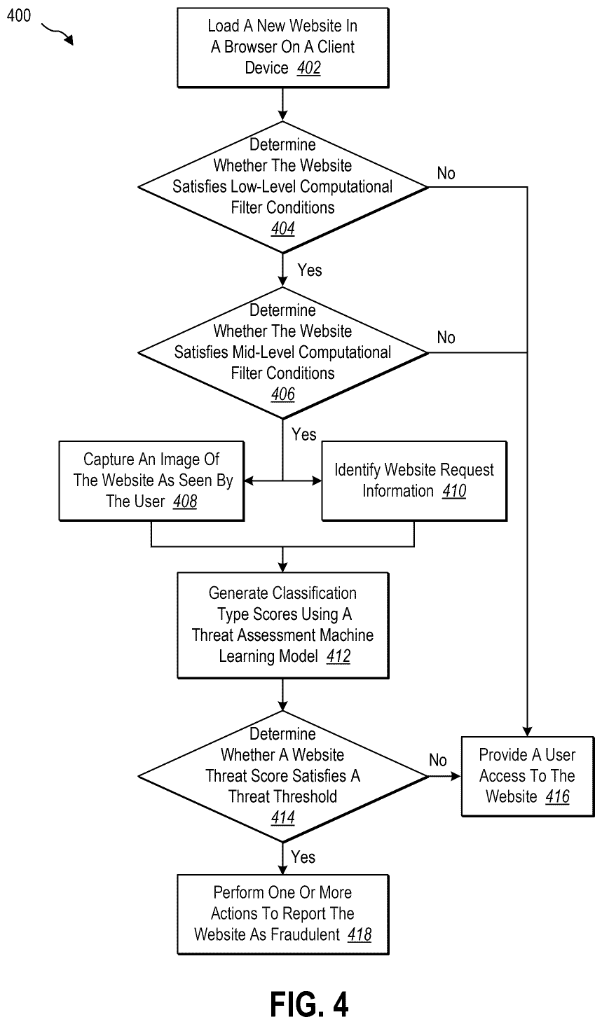

The series of acts 100 includes act 102 of comparing a website to a set of filters to determine whether the website is a scam using a threat assessment model. For example, many websites that a user visits are useful, non-malicious, non-fraudulent sites. Accordingly, computing resources would be wasted if the threat assessment machine learning model was run for each website. Instead, the fraudulent website detection system uses one or more pre-processing conditional filters, rules, or checks to determine whether a website is a candidate for using the threat assessment machine learning model to determine a fraudulent verdict. Additional details regarding verifying a website against a set of conditional filters are provided below in connection with FIG. 4.

Act 104 includes the fraudulent website detection system capturing a screenshot of a website as seen by a user of a client device. For example, if it is determined that the website should be escalated to the threat assessment machine learning model to determine a fraudulent verdict, the fraudulent website detection system obtains various inputs to provide to the threat assessment machine learning model. One of these inputs includes an image capture of the website. Specifically, the fraudulent website detection system captures an image of the website within a browser window as the website is seen by a user. This way, while a fraudulent website may deceive other systems by disguising malicious intent in the DOM, the website cannot hide how it is being displayed to a user.

In some implementations, the fraudulent website detection system also obtains website signals as another input. For example, the fraudulent website detection system obtains website request information, which includes the permissions the website requested and whether those permissions have been granted. Additional details regarding capturing a screenshot image and obtaining other input information are provided below in connection with FIG. 4.

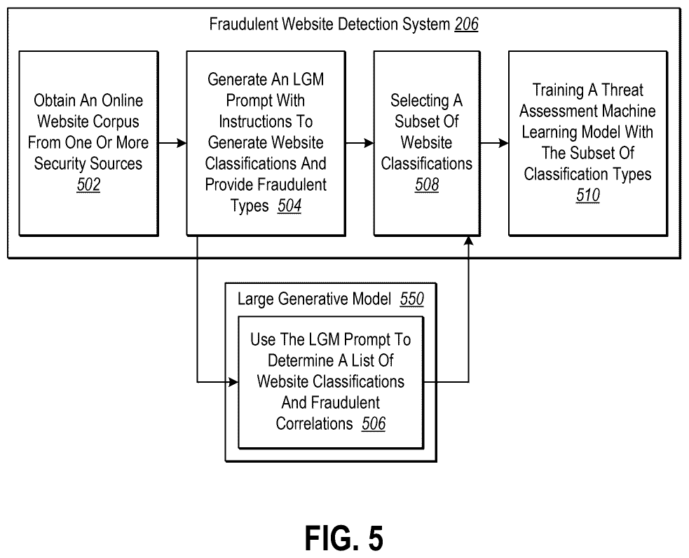

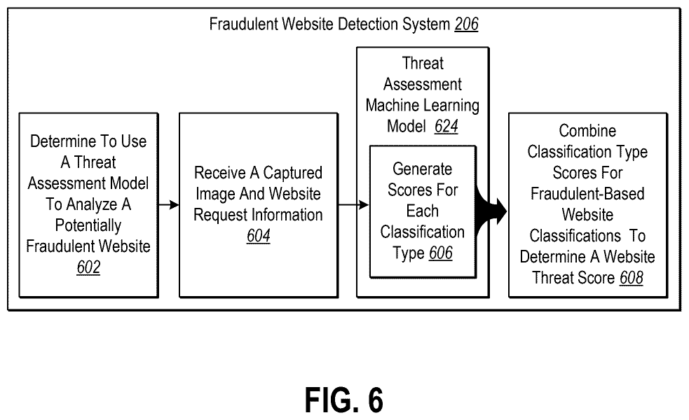

Act 106 includes the fraudulent website detection system using the threat assessment machine learning model to generate classification scores for the website. In various implementations, the fraudulent website detection system provides the website screenshot image and the website request information to the threat assessment machine learning model to locally determine various classifications for the website (e.g., using a local lightweight threat assessment machine learning model). In various implementations, the threat assessment machine learning model generates a classification score for each classification type. Additionally, based on the website classification scores, the fraudulent website detection system determines a website threat potential score for the website, which is used to determine whether the website is fraudulent. Additional details regarding the generation and use of the threat assessment machine learning model to generate website classification type scores are provided in connection with FIG. 5 and FIG. 6 below.

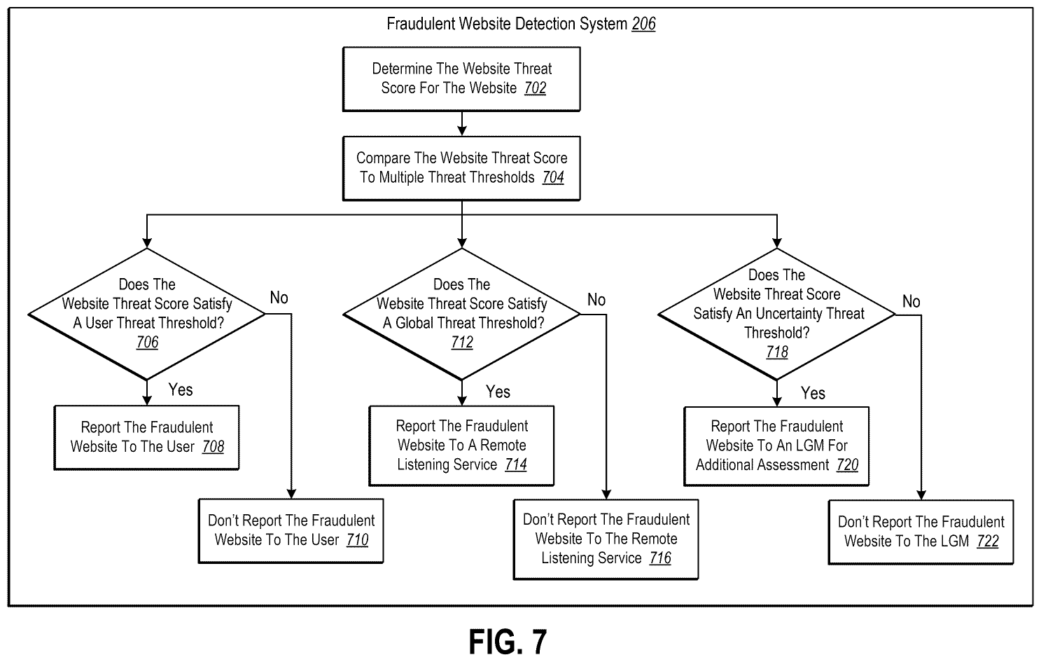

Act 108 includes the fraudulent website detection system preventing the user from accessing the fraudulent website and/or reporting the fraudulent website to a remote listening service based on the website threat potential score exceeding a threat threshold. In various implementations, the fraudulent website detection system compares the website threat score to one or more threat thresholds, such as a user threat threshold or a global threat threshold. Depending on which threat thresholds are satisfied, the fraudulent website detection system performs various actions. For example, the fraudulent website detection system notifies the user and/or prevents them from further accessing or interacting with the fraudulent website. In some cases, the fraudulent website detection system reports the fraudulent website to a remote listening service. Additional details regarding performing preventative actions against the fraudulent website based on threat thresholds and the website threat score are provided below in connection with FIG. 7.

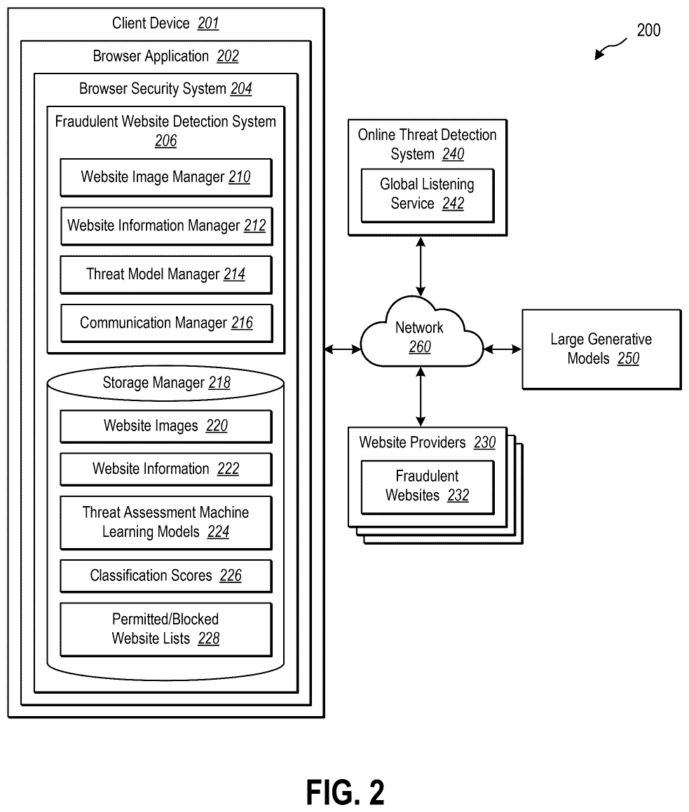

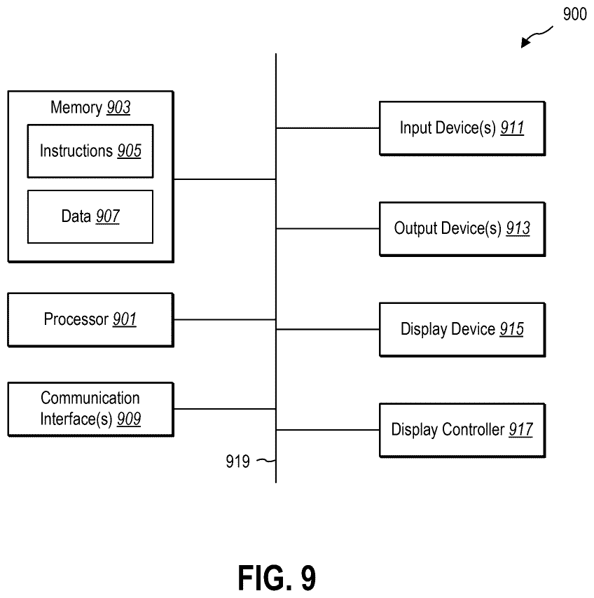

With a general overview in place, additional details are provided regarding the components, features, and elements of the fraudulent website detection system. To illustrate, FIG. 2 shows an example computing environment in which the fraudulent website detection system is implemented according to some implementations. For example, the computing environment 200 includes a client device 201, website providers 230, an online threat detection system 240, and large generative models 250, each connected via a network 260. Additional details regarding the computing devices and networks are provided below in connection with FIG. 9.

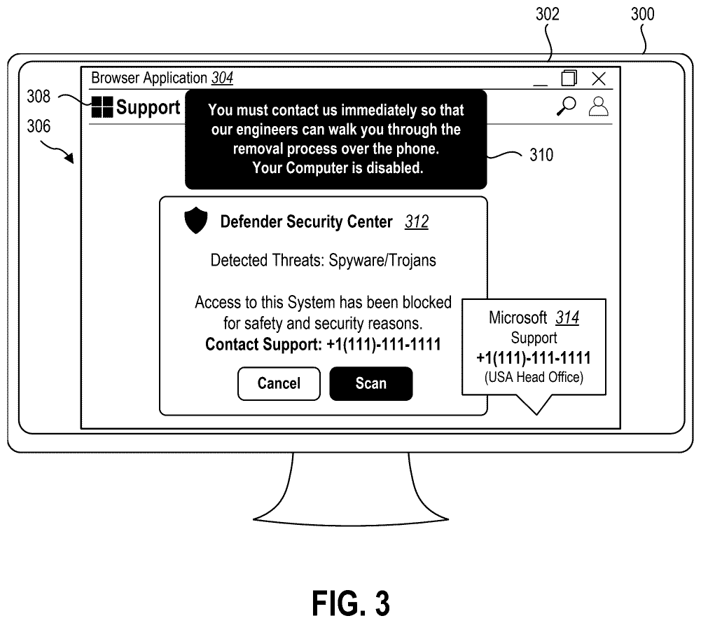

As shown in FIG. 2, the website providers 230 host fraudulent websites 232. In many instances, website providers host non-fraudulent websites (not shown). In various implementations, the website providers 230 use a cloud infrastructure that allows a fraudulent website to quickly launch and remove fraudulent websites. An example of a fraudulent website is provided in FIG. 3.

The online threat detection system 240 provides cloud-based support to the client devices to protect against malicious and fraudulent behaviors. As shown, the online threat detection system 240 includes a global listening service 242. In various implementations, the global listening service 242 is an early warning system to protect users from malicious content while browsing the web or downloading files by screening downloads and websites against known suspicious sites, developers, and files. In various implementations, the global listening service 242 receives reports and security data from numerous sources. The global listening service 242 can also push or provide updates to client devices regarding fraudulent websites. However, the global listening service 242, on its own, may not be able to detect fraudulent websites before they disappear.

As shown, the computing environment 200 includes large generative models 250. In various implementations, one or more large generative models 250 create generative outputs (e.g., LGM outputs) of various types and/or formats, and prompt inputs (e.g., LGM prompts). For example, given a website image and signal information, a large generative model can determine whether the website is fraudulent. Unlike lightweight machine learning models, large generative models are currently computationally expensive, slow to process results, and infeasible to run on most client devices.

As shown, FIG. 2 illustrates the client device 201. The client device 201 may include an operating system (not shown) and various applications, including a browser application 202, as well as other components not shown. The client device 201 may represent a portable or mobile device or another type of personal computer associated with a user. For example, the client device 201 is associated with a user who interacts with a browser application 202 to visit or access websites.

The client device 201 includes the browser application 202 that implements a browser security system 204. In various implementations, the browser security system 204 is responsible for implementing security measures within the browser application 202. In various implementations, the browser security system 204 communicates with the online threat detection system 240 to report security concerns and receive periodic security updates.

FIG. 2 shows that the browser security system 204 implements the fraudulent website detection system 206. In some implementations, the browser security system 204 is implemented elsewhere in the client device 201, such as in another application or within the operating system.

As shown, the fraudulent website detection system 206 includes various components and elements that are implemented in hardware and/or software. For example, the fraudulent website detection system 206 includes a website image manager 210 that captures website images 220 (e.g., screenshots) of what a user sees when a website loads on the client device 201, and a website information manager 212 that obtains website information 222 such as signal information, permissions information, DOM information, referral sites, and/or other website data.

Furthermore, the fraudulent website detection system 206 includes a threat model manager 214 that trains, generates, updates, and/or obtains threat assessment machine learning models 224. Additionally, the threat model manager 214 uses the threat assessment machine learning models 224 to generate classification scores 226 for a website, as well as determine whether the website is fraudulent. The fraudulent website detection system 206 also includes a communication manager 216 that communicates with users of the online threat detection system 240 and large generative models 250 to protect users against fraudulent websites. For example, the communication manager 216 blocks access to or navigation of a website that is determined to be fraudulent or a scam. In another example, the communication manager 216 reports a fraudulent website to the global listening service 242, so that the fraudulent website may be added to the appropriate permitted/blocked website lists 228 shared with other client devices.

In addition, the fraudulent website detection system 206 includes a storage manager 218. As shown, the storage manager 218 includes website images 220, website information 222, one or more of the threat assessment machine learning models 224, classification scores 226, and permitted/blocked website lists 228, each of which is described above in connection with a component of the fraudulent website detection system 206.

Turning to the next figure, FIG. 3 illustrates a graphical user interface of a fraudulent website that initially appears as a legitimate website according to some implementations. As shown, FIG. 3 includes a client device 300 with a graphical user interface 302 that includes a browser application 304. The client device 300 and browser application 304 may represent examples of the client device 201 and the browser application 202 introduced above. For example, the browser application 304 is a web browser application or another application that accesses and displays websites and webpages on the client device 300.

As shown, the browser application 304 displays a fraudulent website 306. The fraudulent website 306 appears to belong to a common technology (tech) company. For example, the fraudulent website 306 includes a tech company logo 308 and other indicia a tech company. From its initial appearance, the fraudulent website 306 appears to the user as a legitimate website.

However, while the fraudulent website 306 appears as a genuine tech company website, it is a fraudulent website designed to scam users of their personal and financial information. To illustrate, upon visiting a fraudulent website, one or more interfaces surface to warn the user of some urgent action. Often, these interfaces are modal windows, which disable most of the page and require users to focus on a specific window before continuing.

As shown in FIG. 3, the fraudulent website 306 includes a first message 310 warning the user of imminent consequences should the user fail to act, and a second message 312 in a modal window with another warning and a number to contact for support. The fraudulent website 306 can include additional interfaces with similar warnings. For example, the fraudulent website 306 includes a third message 314 providing a seemingly legitimate number to call for support. Each of these messages and warnings is designed to have a user contact a bad actor to resolve their seemingly imminent computer problems.

While FIG. 3 shows a fraudulent website 306 imitating a tech company, other fraudulent websites correspond to other types of computer technology. For example, fraudulent websites often imitate computer virus protection companies or other companies that provide computer-based services. However, a fraudulent website may be any type of website that encourages or coerces users to contact bad actors and/or scam users out of personal and/or financial information.

In many cases, when visiting a fraudulent website, the website will request various permissions from the browser application 304 and the client device 300. The fraudulent website uses these permissions to capture or trap a user within the website. For example, the website requests full-screen access, which captures the entire screen to prevent the user from leaving the fraudulent website 306 or the browser application 304; keyboard lock, which prevents the user from using keyboard shortcuts to exit or navigate away from the fraudulent website 306; pointer lock, which locks the mouse within the fraudulent website 306; location access, and/or audio and/or video access, which enables content to be played in the browser application 304.

As mentioned, each of these permission requests is designed to capture the user and prevent them from leaving the fraudulent website 306. By doing so, the fraudulent website 306 adds to the illusion that the client device 300 is infected with a virus that has frozen the other functions of the client device.

While it is common for some websites to request various permissions, such as a video streaming website requesting video permissions, or a game requesting keyboard lock and pointer lock to ensure a user does not accidentally unfocus the game during play, it is less common for websites to request particular combinations of permissions, let alone several or all possible permissions.

In some instances, the browser application 304 is set to implicitly grant certain permissions. For example, the user may have set a preference to allow websites to automatically play audio or video content. In other instances, a user needs to allow a requested permission (e.g., select “allow” in a popup window). In the depicted example, because the website initially appears as a genuine tech company, users often grant permissions before the website starts attacking the user with invasive warnings.

In many cases, while the fraudulent website 306 appears to belong to a tech company, the backend of the website (e.g., the DOM) is designed to carefully hide any malicious intent and fool security detection systems. For example, the website code is often full of unconventional and deceitful practices, such as separating phone numbers into different objects in the code but displaying them as a single number to a user. Additionally, the fraudulent website 306 may include an authentic digital certificate, which satisfies an initial security scan. However, the digital certificate may not match the tech company shown on the website. Indeed, the fraudulent website 306 may fool many security detection systems long enough to escape detection and attack users.

FIG. 4 illustrates an example state diagram that provides an overview of the process of locally detecting fraudulent websites on a client device according to some implementations. As shown, FIG. 4 includes a series of acts 400 and/or states for the fraudulent website detection system 206 to locally detect fraudulent websites on a client device.

The series of acts 400 includes act 402 of loading a new website in a browser on a client device. For example, when a user navigates to a website within a browser application, it begins downloading, parsing the DOM, retrieving content, loading, and/or rendering content. At this stage, the fraudulent website detection system 206 may begin its determination of whether the website is a scam or fraudulent.

Act 404 includes determining whether the website satisfies low-level computational verification filters. In act 404, a satisfied filter condition means that the website appears to be a non-fraudulent website (it cannot be confirmed as legitimate or fraudulent) and will require additional processing to determine its security status. In various implementations, a filter condition is satisfied by either exceeding or not exceeding a threshold depending on if the filter condition is a positive condition or a negative condition. Additionally, filter conditions can be applied as a request or as a trigger to ensure that fraudulent websites are detected at any time if they relate to one or more low-level computational verification filters.

In various implementations, the fraudulent website detection system 206 performs a series or set of checks, conditions, rules, or verifications to determine if the website is legitimate or if it is potentially a fraudulent website that warrants further inspection. In many instances, these filter condition checks are low-computational, which allows the client device to spend minimal resources on verifying legitimate websites. In some instances, the fraudulent website detection system 206 orders the filter conditions from least to most computationally expensive.

The fraudulent website detection system 206 may perform one or more filter conditions. For example, if a current filter condition indicates a legitimate website, the fraudulent website detection system 206 may stop performing additional filter conditions (e.g., the low-level filter conditions are not satisfied). Otherwise, the fraudulent website detection system 206 progresses through each of the filter conditions, performing checks. If some or all of the filter conditions are satisfied (e.g., comparing the website against each filter condition signals or indicates a non-fraudulent website), then the fraudulent website detection system 206 determines to utilize the threat assessment machine learning model, as described below.

Various filter condition examples are now provided. In various implementations, the set of filter conditions includes a reputable website filter condition. In most cases, users are visiting a relatively small group of websites, such as reputable search engine sites, news sites, social media sites, and media content sites. Accordingly, the fraudulent website detection system 206 may compare the uniform resource locator (URL) to a list of reputable websites to detect if the website is legitimate. If a match is found, then the fraudulent website detection system 206 may stop further processing (e.g., the low-level filter condition is not satisfied) and let the user access the website, as shown in act 416.

Another example of a filter condition is a website block list (or an allowed list) that indicates fraudulent, malicious, or other blocked websites (or permitted websites, in the case of an allowed list). In various implementations, the online threat detection system and/or global listening service provide the browser security system with a block list. If the website matches a website on the block list, the fraudulent website detection system 206 knows the website is fraudulent and can stop further filter conditions and/or processing (e.g., the low-level filter condition is not satisfied). In these instances, the fraudulent website detection system 206 may block access to the website and/or notify the user of the website threat (not shown in FIG. 4). Otherwise, if the website is not on the block list, the fraudulent website detection system 206 determines that the filter condition is satisfied and requires additional processing.

An additional example of a filter condition is a typographical and/or grammar filter condition. In various implementations, the fraudulent website detection system 206 determines if the website includes more than a threshold number of typographical, grammar errors, and/or look-alike words (e.g., words that include symbols or characters from other languages that appear to be a typical English word). In some instances, the fraudulent website detection system 206 includes a list of common grammar errors found on fraudulent websites. If there are fewer than the threshold number of errors, the fraudulent website detection system 206 determines whether the threshold is satisfied as being a non-fraudulent website. If there are more than the threshold number of errors, the fraudulent website detection system 206 may determine that the website is suspicious and/or fraudulent and the fraudulent website detection system 206 may block access to the website and/or notify the user of the website threat.

Another example of a filter condition includes a website referral condition. For example, the fraudulent website detection system 206 identifies a previous website or source that referred the user to the website. In some instances, the fraudulent website detection system 206 determines the path, trail, or history of websites recently visited before arriving at the website. Based on analyzing the previous websites, the fraudulent website detection system 206 determines if the website is fraudulent. Otherwise, the fraudulent website detection system 206 does not detect anything suspicious from the previous website (e.g., the filter condition is satisfied as being a non-fraudulent website and requires additional processing).

A further example of a filter condition is a permissions request condition. For instance, the fraudulent website detection system 206 identifies which permissions the fraudulent website requests. If the website requests more than a threshold number of permissions, one or more specific permissions, permissions not normally requested together, and/or permissions not typically requested, the fraudulent website detection system 206 may determine that the filter condition is satisfied and requires additional processing.

Act 404 may include additional or different filter conditions. If each of the low-computational filter conditions is satisfied as being a non-fraudulent website and requiring additional processing, the fraudulent website detection system 206 may progress to act 406. In some implementations, if one of the filter conditions is not satisfied (e.g., the website is deemed to be legitimate), the fraudulent website detection system 206 progresses to act 416 of providing the user access to the website. In some implementations, if one of the filter conditions determines that the website is fraudulent, the fraudulent website detection system 206 may jump to act 414, block access to the website, and/or notify the user of the website threat (each of these actions are not shown in FIG. 4).

Act 406 includes determining whether the website satisfies mid-level computational conditional filters. More particularly, after processing low-level computational conditional filters, the fraudulent website detection system 206 may process mid-level conditional filters before determining whether to use the more expensive threat assessment machine learning model.

An example of a mid-level conditional filter includes a certificate matching condition. For instance, a certificate matching condition matches a digital certificate for the website to the content of the website. In some implementations, the fraudulent website detection system 206 compares the content information of the website to the digital certificate to determine whether a match exists. In some instances, the fraudulent website detection system 206 utilizes one or more low-computing cost machine learning models to obtain content, such as branding or company information, from the website for comparison. If the digital certificate (e.g., the registered owner of the URL) does not match the content, then the fraudulent website detection system 206 determines the filter condition to be satisfied and moves to the next act or acts (e.g., act 408 and act 410). Otherwise, the fraudulent website detection system 206 moves to act 416, as shown.

As shown, if the website satisfies the low-level computational filter conditions and/or the mid-level computational filter conditions, the fraudulent website detection system 206 determines to use the threat assessment machine learning model. Before using the threat assessment machine learning model, the fraudulent website detection system 206 obtains inputs for the threat assessment machine learning model. As shown, the series of acts 400 includes act 408 and act 410.

Act 408 includes capturing an image of the website as seen by a user. For example, the fraudulent website detection system 206 captures a screenshot, screen capture, screen grab, or screen recording of a browser window that captures a webpage as it appears to a user. This way, the fraudulent website detection system 206 captures a true representation of what is being viewed by a user.

In various implementations, the fraudulent website detection system 206 captures multiple images and/or a video of the webpage. For example, the fraudulent website detection system 206 captures different images of the website as the website changes (e.g., additional warning interfaces popup) and/or as the user navigates and reveals additional portions of the website.

In some implementations, the fraudulent website detection system 206 works with the browser application to capture an image of the website. In some implementations, the fraudulent website detection system 206 uses a screen capture application or service. Additionally, the image(s) may be stored in various image formats, including compressed, uncompressed, lossy, and/or lossless formats.

In some implementations, the fraudulent website detection system 206 performs optical character recognition (OCR) on the image. OCR converts text and, in some cases, other content, into a text format. Unlike parsing or extracting information from the DOM, which may include deceptive elements, an OCR of the webpage captures the true version of the website viewed by a user. In these instances, the fraudulent website detection system 206 may provide the converted text file with the image or in place of the image.

Act 410 includes identifying website request information. In some implementations, the website request information includes permissions requested and granted by the website. In various implementations, the website request information includes some or all of the data from the DOM. The website request information may also include other information used in one or more of the filter condition checks, such as the referral website or permissions (as indicated above).

Act 412 includes generating classification type scores using a threat assessment machine learning model. In various implementations, the fraudulent website detection system 206 provides the captured image of the website and the website request information to a threat assessment machine learning model, which generates a score for each of the model's classification types. As noted above, FIG. 5 and FIG. 6 provide additional details regarding generating and using the threat assessment machine learning model to generate website classification type scores.

From the classification type scores, the fraudulent website detection system 206 forms two groups—fraudulent-based scores and non-fraudulent-based scores—based on whether the corresponding classification type is deemed fraudulent. In each group, the fraudulent website detection system 206 combines, aggregates, or averages the scores. For example, the fraudulent-based scores in the first groups are aggregated into a website thread score.

Act 414 includes determining whether the website thread score satisfies a threat threshold. Comparing the website threat score to one or more threat thresholds may deem the website as fraudulent and/or may trigger one or more actions by the fraudulent website detection system 206. Otherwise, if no threat thresholds are satisfied, the fraudulent website detection system 206 advances to act 416 of providing user access to the website, which is deemed non-fraudulent.

Act 418 includes performing one or more actions to report the website as fraudulent. Depending on which threat threshold is satisfied, the fraudulent website detection system 206 performs different sets of actions. For example, if a user threat threshold is satisfied, the fraudulent website detection system 206 may inform a user via the client device and/or prevent further access to the fraudulent website. Alternatively or additionally, if a global threshold is satisfied, the fraudulent website detection system 206 reports the website to a global listening service. Additional details regarding performing preventive actions against the fraudulent website based on threat thresholds and the website threat score are provided below in connection with FIG. 7.

FIG. 5 illustrates an example flow diagram of training a lightweight machine learning model that executes on a client device according to some implementations. As shown, FIG. 5 includes the fraudulent website detection system 206 and a large generative model 550 (LGM). Using the large generative model 550, the fraudulent website detection system 206 performs a series of actions to train a threat assessment machine learning model.

To illustrate, FIG. 5 includes act 502 of the fraudulent website detection system 206 obtaining an online website corpus from one or more security sources. For example, the fraudulent website detection system 206 obtains security alerts, reports, and/or other information regarding websites from security sources.

Act 504 includes the fraudulent website detection system 206 generating an LGM prompt with instructions to generate website classifications and provide fraudulent types. For example, the fraudulent website detection system 206 generates an LGM prompt that instructs the large generative model 550 to process the online website corpus to identify and determine a list of website classifications. In addition, the LGM prompt instructs the large generative model 550 to determine if the website classification is commonly associated with fraudulent activity (e.g., the classification is fraud-based).

Act 506 includes the large generative model 550 using the LGM prompt from the fraudulent website detection system 206 to determine a list of website classifications and fraudulent correlations. Following the instructions from the fraudulent website detection system 206, the LGM outputs website categories or classifications, as well as whether the website corpus has the website classification as primarily legitimate or fraudulent.

Act 508 includes the fraudulent website detection system 206 selecting a subset of website classifications. For example, the large generative model 550 may provide an extensive and/or comprehensive list of classifications. In various implementations, the list is ranked according to topic popularity, classification occurrence frequency, scam frequency, prediction confidence levels, scam severity, or another factor. Accordingly, the fraudulent website detection system 206 selects the top n (e.g., 10, 15, 50, 100 labels) from the list. Often, the fraudulent website detection system 206 limits the list to a certain number of entries to keep processing costs low.

Act 510 includes the fraudulent website detection system 206 training the threat assessment machine learning model with the subset of classification types (i.e., website classifications). For example, the fraudulent website detection system 206 trains a threat assessment machine learning model to determine scores for each selected classification. In particular, the fraudulent website detection system 206 trains the threat assessment machine learning model to determine classification scores based on receiving an image and website request information as input. In various implementations, the threat assessment machine learning model is a SoftMax classifier model that classifies websites for each of the classification types (e.g., labels), where the sum of the classification scores adds up to 1.0 or another normalized value.

In various implementations, the threat assessment machine learning model is not generative but rather a standard classifier model. In alternative implementations, the threat assessment machine learning model is replaced with an SLM designed to determine classification scores or a website threat score from captured images of websites.

FIG. 6 illustrates an example flow diagram of implementing the lightweight machine learning model on a client device to detect fraudulent websites according to some implementations. As shown, FIG. 6 includes the fraudulent website detection system 206 performing a series of actions, including utilizing a threat assessment machine learning model 624. The threat assessment machine learning model 624 may represent a trained SoftMax classifier model or an SLM.

As shown, the series of acts includes act 602 of the fraudulent website detection system 206 determining to use a threat assessment machine learning model to analyze a potentially fraudulent website. For example, after running a website through one or more filter conditions, as described above, the fraudulent website detection system 206 determines to use a threat assessment machine learning model to determine if the website is fraudulent.

Act 604 includes the fraudulent website detection system 206 receiving a captured image and website request information. As described above, the fraudulent website detection system 206 can capture an image or screenshot of the website as seen by a user. In addition, the fraudulent website detection system 206 obtains website request information, which includes permissions information and/or other website information.

Act 606 includes the fraudulent website detection system 206 using the threat assessment machine learning model 624 to generate scores for each classification type. For example, the fraudulent website detection system 206 provides the captured image and the website request information to the threat assessment machine learning model 624, which is a lightweight model located in or accessible to a browser application.

In various implementations, the threat assessment machine learning model 624 processes the image and information and determines a score for each of the model classifications. For example, the threat assessment machine learning model determines, from the inputs, how likely the website belongs to the n-classifications learned by the model. In many instances, the aggregate scores of the classifications equal 1.0 (or 100 using a range of 0-100, etc.).

Act 608 includes the fraudulent website detection system 206 combining classification type scores for fraudulent-based website classifications to determine a website threat score. As mentioned above, each classification within a threat assessment machine learning model has a fraud label that indicates if the classification type is primarily associated with fraudulent websites or legitimate websites. In some instances, the label is a binary value indicating a fraudulent association or a legitimate association. For example, for the classification type of antivirus websites, this classification may be associated with fraudulent websites. Thus, even though some antivirus websites are legitimate, the majority of these sites may be associated with fraudulent websites.

In various implementations, the fraudulent website detection system 206 identifies each of the classification types associated with fraud. For each of these fraud-based classification types, the fraudulent website detection system 206 aggregates or sums the scores together to generate a website threat score for the website. In various implementations, the website threat score maps to a total likelihood that the website is fraudulent due to its association with other fraudulent-based websites.

Once the website threat score is generated, the fraudulent website detection system 206 may determine which actions to perform. To illustrate, FIG. 7 illustrates an example flow diagram of performing one or more reporting actions when a fraudulent website is locally detected according to some implementations. As shown, FIG. 7 includes the fraudulent website detection system 206 performing a series of actions.

The series of actions includes act 702 of determining the website score for the website. As described above, the fraudulent website detection system 206 generates a website threat score that indicates the likelihood that the website is fraudulent.

As mentioned in the previous section, in many implementations, the fraudulent website detection system 206 uses a threat assessment machine learning model located on a client device to determine classification scores and determine the website threat score. Indeed, the fraudulent website detection system 206 determines a website threat score for a website in real time using the client device rather than relying on a remote service or computing device. This way, the fraudulent website detection system 206 quickly and efficiently identifies and acts against fraudulent websites before they have the opportunity to harm or scam users.

Act 704 includes the fraudulent website detection system 206 comparing the website threat score to multiple threat thresholds. For example, the fraudulent website detection system 206 compares the website threat score to a user threat threshold, a global threat threshold, and/or an uncertainty threat threshold. Based on whether the website threat score meets each threat threshold, the fraudulent website detection system 206 performs various actions to report the website.

To illustrate, act 706 includes determining whether the website threat score satisfies a user threat threshold. In various implementations, a user threat threshold is associated with notifying a user that a website is fraudulent. In one or more implementations, the fraudulent website detection system 206 compares the website threat score to the user threat threshold to determine if the website threat score equals or exceeds the user threat threshold.

If the user threat threshold is satisfied, the fraudulent website detection system 206 performs act 708 of reporting the fraudulent website to the user. For example, the fraudulent website detection system 206 provides a notification within the browser security system that the website is fraudulent. In some implementations, the fraudulent website detection system 206 blocks further access to the fraudulent website and/or automatically closes the fraudulent website. In various implementations, the fraudulent website detection system 206 revokes some or all permissions for the fraudulent website. Indeed, the fraudulent website detection system 206 prevents the fraudulent website from harming or scamming the user when the website is being loaded and displayed to the user. Otherwise, if the user threat threshold is not satisfied, the fraudulent website detection system 206 does not report the website to the user, as shown in act 710.

Act 712 includes the fraudulent website detection system 206 determining whether the website threat score satisfies a global threat threshold. In one or more implementations, a global threat threshold is associated with notifying an online threat detection system, such as a global listening service. Often, the global threat threshold is lower than the user threat threshold, however, they may be equal or similar in some situations. Accordingly, the fraudulent website detection system 206 compares the website threat score to the global threat threshold to determine if the website threat score is equal to or exceeds the user threat threshold. In some implementations, the global threat threshold includes multiple threat threshold levels that correspond to performing different actions.

If the global threat threshold is satisfied, the fraudulent website detection system 206 performs act 714 of reporting the fraudulent website to a remote listening service. For example, the fraudulent website detection system 206 provides a message to the global listening service to report the website. If the first global threat threshold is satisfied, the fraudulent website detection system 206 reports the website as potentially fraudulent. If a second, higher global threat threshold level is met, the fraudulent website detection system 206 reports the website as fraudulent (e.g., indicating that the client device has found the website to be fraudulent). However, if the user threat threshold is not satisfied, the fraudulent website detection system 206 does not report the website to the global listening service, as shown in act 716.

If a threshold number of client devices report a website as fraudulent or if the global listening service determines the same verdict, the global listening service may provide a notification to other client devices indicating the fraudulent website. For example, the global listening service adds the fraudulent website to a block list that is sent to connected client devices. In this way, the fraudulent website detection system 206 operating on one or more client devices, through their rapid local detection, enables the global listening service to rapidly and quickly discover the fraudulent website and alert other client devices of the fraudulent website within minutes, rather than hours, of the fraudulent website launching.

In various implementations, when reporting a website, the fraudulent website detection system 206 may provide additional website information, such as the captured website image (or an OCR/converted text version to save bandwidth) and/or website request information. This may allow the global listening service to determine its own verdict regarding the website using more complex models.

Additionally, in some instances, based on receiving other reports and alerts, the global listening service may determine a fraudulent website verdict for the website using the existing methods described above (e.g., the global listening service may use heuristic models, AI models, LLMs, or other algorithms to determine whether a website is a scam based on all signals and reporting information it receives from various security sources). While these methods are too slow to prevent Patient 0 user attacks, an instance of the fraudulent website detection system on the global listening service may use these verdicts to train (or re-train) and improve the threat assessment machine learning models located on client devices. In some implementations, additional data, such as third-party data may also be used to improve threat assessment machine learning models.

To illustrate, a fraudulent website detection system on the global listening service may compare the locally rendered verdicts for websites over a time period to verdicts from the same websites rendered at the global listening service. Using this information, the fraudulent website detection system updates the threat assessment machine learning model to generate fraudulent website verdicts with improved accuracy. The fraudulent website detection system may achieve greater accuracy of results when data from several client devices are combined to update the threat assessment machine learning model. The fraudulent website detection system may then provide the updated threat assessment machine learning model to all of the client devices that communicate with the global listening service.

Act 718 includes the fraudulent website detection system 206 determining whether the website threat score satisfies an uncertainty threat threshold. In one or more implementations, an uncertainty threat threshold is associated with notifying an external model, such as an LGM, that support is needed to confidently render a fraudulent website verdict. Frequently, the uncertainty threat threshold is lower than the user threat threshold and/or the global threat threshold. Often, the uncertainty threat threshold includes a range of values (e.g., a minimum value and a maximum value). Accordingly, the fraudulent website detection system 206 compares the website threat score to the uncertainty threat threshold.

If the uncertainty threat threshold is satisfied (e.g., the website threat score falls within the uncertainty threat threshold range), the fraudulent website detection system 206 performs act 720 of reporting the fraudulent website to an LGM for additional assessment. For example, the fraudulent website detection system 206 provides the captured image (or an OCR/converted text version to save on bandwidth), the website request information, and/or additional website information for the LGM to render a fraudulent website verdict. In some instances, the fraudulent website verdict is only reported if the fraudulent website detection system 206 also determines that the verdict is more common than anticipated (so as to not overwhelm the remote listening service receiving the reports). If the uncertainty threat threshold is not satisfied, the fraudulent website detection system 206 does not report the website to the LGM, as shown in act 722.

While slower, in some instances, the LGM may return a verdict in time to prevent the user from interacting with a fraudulent website. In some implementations, while waiting for the LGM to process, the fraudulent website detection system 206 pauses user interactions with the website and/or provides a message to the user indicating that the website may be fraudulent and to wait for confirmation.

In various implementations, to maintain privacy, the fraudulent website detection system 206 pre-processes the data sent to the LGM to remove personally identifiable information (PII). As another benefit, while processing locally on the client device, the fraudulent website detection system 206 provides enhanced security by keeping all PII private while rendering a fraudulent website verdict.

While FIG. 7 shows three threat thresholds, the fraudulent website detection system 206 may employ additional or different threat thresholds. Additionally, each of the threat thresholds may include different levels that result in different reporting action levels. Furthermore, the fraudulent website detection system 206 may perform any one of these actions independently or in combination (e.g., warning a user may also trigger a report to the global listening service).

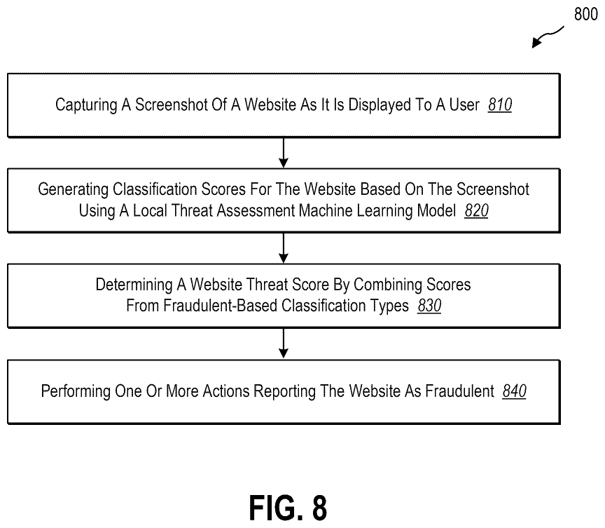

Turning now to FIG. 8, this figure illustrates an example series of acts in a computer-implemented method for locally determining one or more fraudulent websites on a computing device, according to some implementations. While FIG. 8 illustrates acts according to one or more implementations, alternative implementations may omit, add, reorder, and/or modify any of the acts shown.

The acts in FIG. 8 can be performed as part of a method (e.g., a computer-implemented method). Alternatively, a computer-readable medium can include instructions that, when executed by a processing system with a processor, cause a computing device to perform the acts in FIG. 8. In some implementations, a system (e.g., a processing system comprising a processor) can perform the acts in FIG. 8. For example, the system includes a processing system and a computer memory including instructions that, when executed by the processing system, cause the system to perform various actions, operations, or steps.

To illustrate, in FIG. 8, the series of acts 800 includes act 810 of capturing a screenshot of a website as it is displayed to a user. For instance, in example implementations, act 810 involves capturing an image of a website that is loaded on a client device. In some implementations, act 810 includes determining to use the threat assessment machine learning model to assess the website for fraudulent behavior upon detecting the website that is loaded on the client device. In some implementations, act 810 includes determining to use the threat assessment machine learning model based on verifying one or more low-computational filter conditions.

In some implementations, in connection with act 810, the one or more low-computational filter conditions include a first filter condition that verifies whether the website is associated with a commonly accessed website, a second filter condition that verifies whether the website is not included on a fraudulent website list, a third filter condition that verifies whether the website includes a threshold number of grammar and typographical errors, a fourth filter condition that provides a verification based on a previous website that linked to the website, and/or a fifth filter condition that provides a verification based on client device permissions requested by the website.

In some implementations, act 810 includes detecting one or more client device permissions requested by the website, determining one or more accepted permissions associated with the one or more client device permissions requested, and generating the website request information to indicate the one or more client device permissions and the one or more accepted permissions. In some instances, capturing the image of the website that is loaded on the client device includes taking a screen capture of the website as it appears within a browser window to a user.

As further shown, the series of acts 800 includes act 820 of generating classification scores for the website based on the screenshot using a local threat assessment machine learning model. For instance, in example implementations, act 820 involves generating a set of classification scores for the website based on website request information and the image using a threat assessment machine learning model executed locally on the client device. In some implementations, the threat assessment machine learning model determines a fraudulent website verdict, indicating that the website is fraudulent, before the client device receives additional user input associated with the website. In some cases, the threat assessment classification machine learning model does not use a remote resource to determine the set of classification scores for the website.

In some implementations, act 820 includes providing a corpus of fraudulent-based website information to a large generative model, along with instructions to determine website classification types and their corresponding fraudulent associations, selecting a set of website classification types, and generating the threat assessment machine learning model based on the set of website classification types to generate a classification score for each of the website classification types for candidate websites. In some implementations, act 820 includes converting the image of the website to converted text before providing the converted text of the image to the threat assessment machine learning model.

As further shown, the series of acts 800 includes act 830 of determining a website threat score by combining scores from fraud-based classification types. For instance, in some implementations, act 830 involves determining a website threat score for the website based on aggregating a subset of the set of classification scores. In various implementations, classification types of the threat assessment machine learning model have a binary value indicating a fraudulent association. In some implementations, determining the website threat score for the website includes generating a classification type subset based on identifying fraudulent associations for each of the classification types and generating the subset of the set of classification scores based on classification scores generated from the classification type subset.

Furthermore, the series of acts 800 includes act 840 of performing one or more actions reporting the website as fraudulent. For instance, in example implementations, act 840 involves performing one or more actions reporting the website as fraudulent to prevent fraudulent activity, based on the website threat score for the website satisfying one or more threat thresholds. In some instances, act 840 includes determining a fraudulent website verdict for the website and preventing a user associated with the client device from accessing the website further, based on determining that the website threat score for the website satisfies a user threat threshold.

In some instances, act 840 includes determining that the website threat score for the website satisfies a user threat threshold and notifying a user associated with the client device that the website is fraudulent based on the user threat threshold being satisfied. In some instances, act 840 includes determining that the website threat score for the website satisfies a global threat threshold and reporting the website to a fraudulent listener service based on the global threat threshold being satisfied. In some instances, reporting the website includes providing a fraudulent website verdict, the image of the website, and the website request information to the fraudulent listener service. In some cases, act 840 includes receiving one or more websites to add to a fraudulent website list for blocking fraudulent websites from the fraudulent listener service.

FIG. 9 illustrates certain components that may be included within a computer system 900. The computer system 900 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 900 represents one or more of the client devices, server devices, or other computing devices described above. For example, the computer system 900 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 900 includes a processing system including a processor 901. The processor 901 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 901 may be referred to as a central processing unit (CPU) and may cause computer-implemented instructions to be performed. Although the processor 901 shown is just a single processor in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 905 and the data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during the execution of the instructions 905 by the processor 901.

A computer system 900 may also include one or more communication interface(s) 909 for communicating with other electronic devices. The one or more communication interface(s) 909 may be based on wired communication technology, wireless communication technology, or both. Some examples of the one or more communication interface(s) 909 include a Universal Serial Bus (USB), an Ethernet adapter, a wireless adapter that operates according to an Institute of Electrical and Electronics Engineers (IEEE) 902.11 wireless communication protocol, a Bluetooth® wireless communication adapter, and an infrared (IR) communication port.

A computer system 900 may also include one or more input device(s) 911 and one or more output device(s) 913. Some examples of the one or more input device(s) 911 include a keyboard, mouse, microphone, remote control device, button, joystick, trackball, touchpad, and light pen. Some examples of the one or more output device(s) 913 include a speaker and a printer. A specific type of output device that is typically included in a computer system 900 is a display device 915. The display device 915 used with implementations disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For clarity, the various buses are illustrated in FIG. 9 as a bus system 919.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining one or more fraudulent websites locally on a computing device, comprising:
capturing an image of a website that is loaded on a client device;
generating a set of classification scores for the website based on website request information and the image using a threat assessment machine learning model executed locally on the client device;
determining a website threat score for the website based on aggregating a subset of the set of classification scores; and
based on the website threat score for the website satisfying one or more threat thresholds, performing one or more actions reporting the website as fraudulent.

2. The computer-implemented method of claim 1, further comprising determining to use the threat assessment machine learning model to assess the website for fraudulent behavior in response to detecting the website that is loaded on the client device.

3. The computer-implemented method of claim 2, further comprising determining to use the threat assessment machine learning model based on verifying one or more low-computational filter conditions.

4. The computer-implemented method of claim 3, wherein the one or more low-computational filter conditions include:
a first filter condition that verifies whether the website is associated with a commonly accessed website;
a second filter condition that verifies whether the website is not included on a fraudulent website list;
a third filter condition that verifies whether the website includes a threshold number of grammar and typographical errors;
a fourth filter condition that provides verification based on a previous website that linked to the website; and
a fifth filter condition that provides verification based on client device permissions requested by the website.

5. The computer-implemented method of claim 1, wherein capturing the image of the website that is loaded on the client device includes capturing a screen capture of the website as it appears within a browser window to a user.

6. The computer-implemented method of claim 1, further comprising:
detecting one or more client device permissions requested by the website;
determining one or more accepted permissions associated with the one or more client device permissions requested; and
generating the website request information to indicate the one or more client device permissions and the one or more accepted permissions.

7. The computer-implemented method of claim 1, further comprising:
providing a corpus of fraudulent-based website information to a large generative model with instructions to determine website classification types and corresponding fraudulent associations;
selecting a set of website classification types; and
generating the threat assessment machine learning model based on the set of website classification types to generate a classification score for each of the website classification types for candidate websites.

8. The computer-implemented method of claim 1, wherein the threat assessment machine learning model determines a fraudulent website verdict that the website is fraudulent before the client device receives additional user input associated with the website.

9. The computer-implemented method of claim 1, further comprising converting the image of the website to converted text before providing the converted text of the image to the threat assessment machine learning model.

10. The computer-implemented method of claim 1, wherein classification types of the threat assessment machine learning model have a binary value indicating a fraudulent association.

11. The computer-implemented method of claim 10, wherein determining the website threat score for the website includes:
generating a classification type subset based on identifying fraudulent associations for each of the classification types; and
generating the subset of the set of classification scores based on classification scores generated from the classification type subset.

12. The computer-implemented method of claim 1, further comprising:
determining that the website threat score for the website satisfies a user threat threshold; and
based on the user threat threshold being satisfied, notifying a user associated with the client device that the website is fraudulent.

13. The computer-implemented method of claim 1, further comprising:
determining that the website threat score for the website satisfies a global threat threshold; and
based on the global threat threshold being satisfied, reporting the website to a fraudulent listener service.

14. The computer-implemented method of claim 13, wherein reporting the website includes providing a fraudulent website verdict, the image of the website, and the website request information to the fraudulent listener service.

15. The computer-implemented method of claim 14, further comprising receiving, from the fraudulent listener service, one or more websites to add to a fraudulent website list for blocking fraudulent websites.

16. A system comprising:
a processing system; and
a computer memory comprising instructions that, when executed by the processing system, cause the system to perform operations of:
capturing an image of a website that is loaded on a client device;
generating a set of classification scores for the website based on website request information and the image using a threat assessment machine learning model executed locally on the client device;
determining a website threat score for the website based on aggregating a subset of the set of classification scores; and
based on the website threat score for the website satisfying one or more threat thresholds, performing one or more actions reporting the website as fraudulent.

17. The system of claim 16, wherein the operations further include:
determining that the website threat score for the website satisfies a user threat threshold; and
based on the user threat threshold being satisfied, notifying a user associated with the client device that the website is fraudulent.

18. The system of claim 16, wherein the operations further include:
determining that the website threat score for the website satisfies a global threat threshold; and
based on the global threat threshold being satisfied, reporting the website to a fraudulent listener service.

19. A computer-implemented method for determining one or more fraudulent websites locally on a computing device, comprising:
capturing an image of a website that is loaded on a client device;
generating a set of classification scores for the website based on website request information and the image using a threat assessment classification machine learning model executed locally on the client device;
determining a website threat score for the website based on aggregating a subset of classification scores; and
based on determining that the website threat score for the website satisfies a user threat threshold, determining a fraudulent website verdict for the website and preventing a user associated with the client device from further accessing the website.

20. The computer-implemented method of claim 19, wherein the threat assessment classification machine learning model does not use a remote resource to determine the set of classification scores for the website.
